(19) United States
(12) Patent Application Publication
(10) Pub. No.: US 2025/0036849 A1
(43) Pub. Date: Jan. 30, 2025

(54) REALISTIC TEST CIRCUIT GENERATION THROUGH RANDOM CIRCUIT LAYER BLOCKS

(71) Applicant: Siemens Industry Software Inc., Plano, TX (US)

(72) Inventors: Yuansheng Ma, Fremont, CA (US); Jiechang Hou, Portland, OR (US); Joerg Mellmann, Williston, VT (US)

(73) Assignee: Siemens Industry Software Inc., Plano, TX (US)

(21) Appl. No.: 18/361,012

(22) Filed: Jul. 28, 2023

(51) Int. Cl. G06F 30/398

(52) U.S. Cl. CPC G06F 30/398; G06F 2119/18

(57) ABSTRACT

A method may support realistic test circuit generation through random circuit layer blocks. The method may include accessing a set of circuit layer blocks, performing a block-level design rule check (DRC) process on the set of circuit layer blocks, wherein the block-level DRC process applies selected design rules that are a subset of a design rule set for a circuit manufacturing process, and obtaining a set of clean circuit layer blocks by discarding circuit layer blocks in the accessed set of circuit layer blocks that fail the block-level DRC process and keeping circuit layer blocks in the accessed set of circuit layer blocks that pass the block-level DRC process. The method may also include generating a test circuit layer formed through randomly selected circuit blocks from the set of clean circuit layer blocks and utilizing the test circuit layer in support of testing the circuit manufacturing process.

### BACKGROUND

Electronic circuits, such as integrated circuits, are used in nearly every facet of modern society, from automobiles to microwaves to personal computers. Design of circuits may involve many steps, known as a “design flow.” The particular steps of a design flow are often dependent upon the type of microcircuit being designed, its complexity, the design team, and the circuit fabricator or foundry that will manufacture the circuit. Electronic design automation (EDA) applications support the design and verification of circuits prior to fabrication. EDA applications may implement various EDA procedures, e.g., functions, tools, or features to analyze, test, or verify a circuit design at various stages of the design flow.

### BRIEF DESCRIPTION OF THE DRAWINGS

Certain examples are described in the following detailed description and in reference to the drawings.

FIG. 1 shows an example of a computing system that supports realistic test circuit generation through random circuit layer blocks.

FIG. 2 shows an example generation of a test circuit layer via the realistic test circuit generation technology of the present disclosure.

FIG. 3 shows an example of a test circuit that can be generated through the realistic test circuit generation technology of the present disclosure.

FIG. 4 shows an example of logic that a computing system may implement to support realistic test circuit generation through random circuit layer blocks.

FIG. 5 shows an example of a computing system that supports realistic test circuit generation through random circuit layer blocks.

### DETAILED DESCRIPTION

As modern circuit designs increase in complexity and capability, verification of both circuit designs and circuit manufacturing processes becomes increasingly challenging. As the physical sizes of transistors for technology nodes continue to decrease, verification of the manufacturing processes and design rules for such technology node sizes becomes increasingly difficult. For a new technology node or a technology node under recent development, chip foundries or circuit manufacturers can develop processes to manufacture circuits at such technology nodes subject to design rules specific to the technology node. Often absent in early development stages of a new technology node are viable chip designs that are particularly designed for the new technology node. The design and development of functional chips, especially at new technology nodes, can be a lengthy and resource-consuming process, as circuit designers are often starting from the ground up to produce designs specific to the new technology node. Moreover, verification of manufacturing processes at new technology nodes can be more effective with a large number of test chips, and foundries can benefit from a greater number of test patterns, chips, or any circuit designs constructed for a new technology node.

Some test chip generation techniques exist to aid foundry verification of technology node manufacturing processes and design rules. Conventional software techniques may produce test chips as a whole, with a top-down approach wherein inputs can comprise a particular chip size, upon which the software can output a randomly generated chip design as whole. However, such conventional techniques often produce test chips that fail to reflect or include characteristics, patterns, or attributes of actual chip designs (e.g., functional chips, as opposed to randomly generated test chips). Often lacking in such top-down processes are considerations of fundamental IC design processes, so purely random chip generation can fail to mimic actual IC products. As such, testing circuit manufacturing processes with these unrealistic test chips can have limited effectiveness in stressing manufacturing process constraints or otherwise fail to provide meaningful analyses and verification for tested circuit manufacturing processes of technology nodes.

The disclosure herein may provide systems, methods, devices, and logic for realistic test circuit generation through random circuit layer blocks. As described in greater detail herein, the realistic test circuit generation technology of the present disclosure may provide a bottom-up approach for generation of test circuits, doing through so utilization of circuit layer blocks. Circuit layer blocks of the present disclosure may include any layout-level design blocks that are used to build a test circuit design. In particular, circuit layer blocks may mimic design cells (e.g., standard cells) of an IC design and can provide, in a some sense, a standard cell library for test chip generation. As described herein, circuit layer blocks may be randomly generated, allowing for speedy large-scale generation of such chip building blocks, which can provide an efficient mechanism to build a large library of random options to build up a test chip design. And while random patterns of the circuit layer blocks may not provide or implement actual circuit functionality, generation of the circuit layer blocks may be controlled to particularly stress particular design rules, meet certain similarity criteria with existing standard design cells, or according to any other generation criteria to better mimic functional chip designs.

Through circuit layer blocks formed from random patterns, the realistic test circuit generation technology of the present disclosure may support construction or larger test circuits, such as circuit layers and full-chip designs. Design rule check (DRC) processes can be applied, both at a block-level and at a layer/chip level, allowing for verification of circuit components to increase realism and further mimic actual IC designs and implement steps of actual IC design processes. Construction of full-test chips can be performed through random placement of circuit layer blocks, and in some cases account for utilization criteria or other IC design criteria. As such, the realistic test circuit generation technology of the present disclosure can support generation of full test layers and full test chips using circuit layer blocks. The test circuits generated through the present disclosure may provide increased realism, allowing foundries and chip manufacturers to test, validate, or stress manufacturing processes and technology nodes with increased effectiveness, while also providing efficiency benefits of random pattern generations.

These and other aspects of realistic test circuit generation technology according to the present disclosure and the technical benefits of such realistic test circuit generation technology are described in greater detail herein.

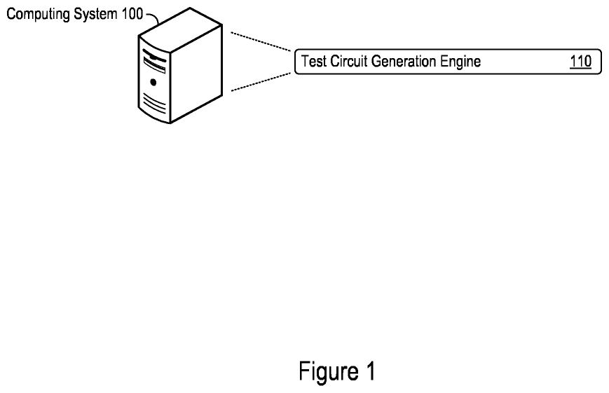

FIG. 1 shows an example of a computing system 100 that supports realistic test circuit generation through random circuit layer blocks. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, instantiates, executes, supports, or implements an EDA application or EDA system that supports circuit design and analysis, and may accordingly provide or implement any of the realistic test circuit generation technology described herein.

As an example implementation to support any combination of the realistic test circuit generation technology described herein, the computing system 100 shown in FIG. 1 includes a test circuit generation engine 110. The computing system 100 may implement the test circuit generation engine 110 (including components thereof) in various ways, for example as hardware and programming. The programming for the test circuit generation engine 110 may take the form of processor-executable instructions stored on a non-transitory machine-readable storage medium and the hardware for the test circuit generation engine 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the test circuit generation engine 110 may access a set of circuit layer blocks, which may be generated as random layout patterns and according to any number of block criteria as described herein. In operation, the test circuit generation engine 110 may further perform a block-level DRC process on the set of circuit layer blocks, wherein the block-level DRC process applies selected design rules that are a subset of a design rule set for a circuit manufacturing process and obtain a set of clean circuit layer blocks, for example doing so by discarding circuit layer blocks in the accessed set of circuit layer blocks that fail the block-level DRC process and keeping circuit layer blocks in the accessed set of circuit layer blocks that pass the block-level DRC process. The test circuit generation engine 110 may further generate a test circuit layer formed through randomly selected circuit blocks from the set of clean circuit layer blocks and utilize the test circuit layer in support of testing the circuit manufacturing process.

These and other aspects of realistic test circuit generation technology according to the present disclosure are described in greater detail next.

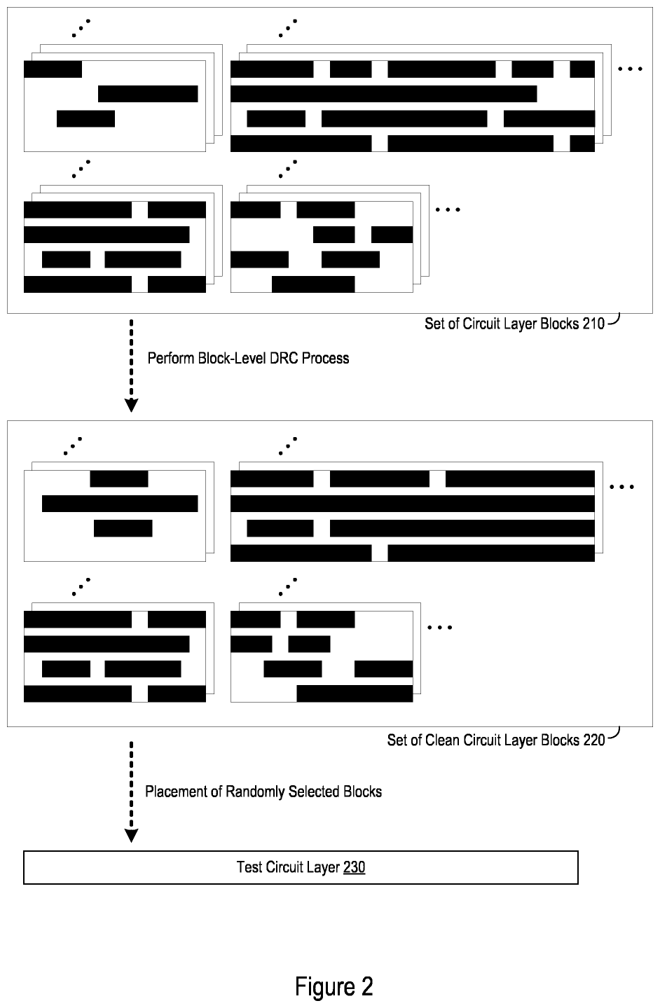

FIG. 2 shows an example generation of a test circuit layer via the realistic test circuit generation technology of the present disclosure. The example of FIG. 2 is presented using the test circuit generation engine 110 as an example implementation, though any suitable implementation is contemplated herein. In support of realistic test circuit generation, the test circuit generation engine 110 may access a set of circuit layer blocks, such as the set of circuit layer blocks 210 shown in FIG. 2. A circuit layer block may refer to any physical layout circuit section, and may thus take the form of layout clips, layout patterns, or any other circuit section. The circuit layer blocks accessed by the test circuit generation engine 110 may be randomly generated, e.g., as random layout patterns. Accessed circuit layer blocks may include circuit layout blocks of differing size, e.g., 300 nanometer (nm)×180 nm blocks, 300 nm×120 nm blocks, 600 nm×180 nm blocks, as but a few example sizes. The set of accessed circuit layer blocks may be in any suitable format, shape, size, and with any type of characteristics in support of test circuit generation as described herein.

In some implementations, the test circuit generation engine 110 may itself generate individual circuit layer blocks of the set of circuit layer blocks 210. In doing so, the test circuit generation engine 110 may generate the set of circuit layout blocks 210 as random layout patterns for a circuit design. Such random generation can be performed quickly, allowing the test circuit generation engine 110 to generate a large number of circuit layer blocks for use in building larger circuit sections (e.g., chip layers and full circuit designs). In some examples, the test circuit generation engine 110 may generate the set of circuit layer blocks 210 to include thousands or millions of randomly generated circuit section layouts. Any suitable random pattern generation techniques can be employed by the test circuit generation engine 110 to generate the set of circuit layout blocks 210.

Though generation of the circuit layer blocks may be through random patterning, the test circuit generation engine 110 may control circuit layer block generation through any number of block criteria. A block criterion may refer to any constraint, parameter, configuration, or design characteristic that circuit layer blocks are to satisfy. Various examples of block criteria are presented herein, and the test circuit generation engine 110 may apply any combination of the block criteria described herein to generate or otherwise access circuit layer blocks.

As one example of block criteria, the test circuit generation engine 110 may generate circuit layer blocks of a particular block size. Such block sizes may be predetermined or user-specified, e.g., as specific dimension values such as 300 nm×180 nm blocks. Different block sizes may be applied to generation of a set of circuit layer blocks, for example for a specified number of circuit layer blocks (e.g., 10,000 circuit layer blocks at a first block size and 20,000 circuit layer blocks at a second block size), as specified percentages (e.g., 50% of the set of circuit layer blocks 210 generated in a first block size, 25% in a second block size, and 25% in a third block size), or in any other suitable manner.

As another example, the test circuit generation engine 110 may apply a density block criterion in the generation of circuit layout blocks. A density block criterion may specify specific layout density values or layout density ranges for circuit layout blocks to satisfy. Layout density may measure a percentage of the circuit block in which a layout pattern occupies, e.g., a percentage of the block space covered with a layout pattern (e.g., geometric feature). Density block criteria may be specified in tiers, for example “high density”, “medium density”, and “low density” constraints for circuit layout blocks, and each tier may have a specified density value or value range that generated circuit layer blocks need to satisfy.

As yet another example, the test circuit generation engine 110 may apply block criteria based on a design rule set for a technology node or a specific circuit manufacturing process. As such, the test circuit generation engine 110 may generate a set of circuit layout blocks as random layout patterns that stress selected design rules of a circuit manufacturing process. The selected design rules may include block-level DRC rules, such as allowed extrema (e.g., minimum or maximum values) for various layout characteristics, such as end-to-end (ETE) spacing, widths, lengths, area, spacing, and the like. Stressing the selected design rules may include generating circuit layer blocks with characteristics at the allowed extrema, or within a specified threshold to the extrema. In some implementations, the block criteria may specify any number of criteria that reference any number of features, parameters, configurations, or characteristics of standard cell library. Examples of such criteria may include cell dimensions, density requirements, allowed pattern lengths and widths, shape requirements, and such.

Block criteria may specify a similarity requirement to any number of known patterns (e.g., from an existing standard cell library). Similarity measurements may be applied by the test circuit generation engine 110 in various ways. In some implementations, the test circuit generation engine 110 may measure similarity of random layout patterns to standard cells by partitioning the compared patterns, blocks, and cells and measuring a similarity value for each of the partitioned spaces. For example, to measure the similarity between a generated random layout pattern with a standard cell, the test circuit generation engine 110 may partition the random pattern and the standard cell into a 3×3 grid, with nine (9) total partitions. For each partition, the test circuit generation engine 110 may measure similarity between corresponding partitions of the random pattern and standard cell based on layout overlap (e.g., with a value between 0-100% based on whether similarity of occupied and unoccupied layout portions, which may be performed on a pixel-based granularity or at any other specific granularity). The block criteria may specific different tolerances for different partitions, e.g., a middle/center partition requiring 80%+ similarity between the random pattern and standard cell and other partitions requiring a 50%+ similarity. While examples of similarity measures are presented herein, any suitable comparison and requirements between circuit layout blocks and standard cells (or any reference cell, layout pattern, or circuit portion) is contemplated herein.

While some examples of block criteria are presented herein, the test circuit generation engine 110 may apply any suitable constraints or configurations to control characteristics of a set of circuit layer blocks. Any combination of suitable block criteria are contemplated herein.

In some of the examples described herein, the test circuit generation engine 110 generates a set of circuit layer blocks using block criteria. In such examples, generation of circuit layer blocks may be controlled through the block criteria, though still in a random manner to support efficient generation. In other examples, the test circuit generation engine 110 may generate a number of random layout patterns (e.g., in various sizes), and then apply any combination of block criteria to filter the generated random layout patterns. In doing so, the test circuit generation engine 110 may likewise access a set of circuit layer blocks that satisfy the block criteria (as the random layout patterns have been filtered to satisfy the block criteria). And while many of the examples presented herein specify the test circuit generation engine 110 generating circuit layout blocks according to the block criteria, the test circuit generation engine 110 need not itself generate the circuit layer blocks. In any suitable manner, the test circuit generation engine 110 access the set of circuit layer blocks that satisfy any of the block criteria described herein.

In any of the ways described herein, the test circuit generation engine 110 may access a set of circuit layer blocks 210, which may be comprised of random layout patterns that satisfy block criteria. The set of circuit layer blocks 210 may, in some sense, form the basis of a cell library through which test circuits can be generated. In order to improve test circuit generations, the test circuit generation engine 110 may apply DRC processes to ensure circuit layer blocks are “clean”, e.g., satisfy foundry rule sets at a block level. For instance, the test circuit generation 110 may perform a block-level DRC process on the set of circuit layer blocks 210. The block-level DRC process may apply selected design rules that are a subset of a design rule set for a circuit manufacturing process or foundry, e.g., those rules applicable or relevant to block level patterns (and excluding rules in a foundry's design rule set applicable to a whole chip or multiple chip layers).

Through DRC processes, the test circuit generation engine 110 may obtain clean circuit layer blocks that satisfy a rule set of a circuit manufacturing process. In FIG. 2, the test circuit generation engine 110 obtains a set of clean circuit layer blocks 220, for example by discarding circuit layer blocks in the set of circuit layer blocks 210 that fail the block-level DRC process and keeping circuit layer blocks in the accessed set of circuit layer blocks 210 that pass the block-level DRC process. The set of clean circuit layer blocks 220 may together form a building block library comprised of DRC-cleaned random patterns. Through such a building block library, the test circuit generation engine 110 may construct larger circuit sections, such as circuit layers and full-chip designs.

In the example of FIG. 2, the test circuit generation engine 110 generates the test circuit layer 230. The test circuit layer 230 may be a layer of a test chip, generated using random layout patterns of the set of clean circuit layer blocks 220. To generate the test circuit layer 230, the test circuit generation engine 110 may place randomly selected blocks from the set of clean circuit layer blocks 230 until an entire circuit layer is formed. The test circuit generation engine 110 may apply any suitable random selection processes to select blocks from the set of clean circuit layer blocks 230, and then sequentially place the randomly selected blocks to form the test circuit layer 230.

In generating the test circuit layer 230 or any multi-block circuit section, the test circuit generation engine 110 may set an empty or blank rectangle layout (e.g., at a user-defined size). Then, the test circuit generation engine 110 may randomly select blocks from the set of clean circuit layer blocks 230 and place each selected clean circuit layer block in the rectangle layout until the entire layout is covered. In some implementations, the test circuit generation engine 110 may support such layout generation with any number of configurable constraints, such as a controllable utilization rate that the rectangular layout satisfies (and utilization may refer to a portion of a circuit that is non-empty or covered with physical elements), support of overlapping block placements (e.g., with a user-defined overlapping size), random flip or rotations performed on the selected blocks, or any other suitable generation techniques or constraints. Through such features, test circuit layers and chips may be generated with varied patterns and to mimic realistic designs.

Through such random placement, the test circuit generation engine 110 may generate the test circuit layer 230. As the building block library formed by the set of clean circuit layer blocks 220 may be efficiently generated through random layout patterns, and random selection and placement may also be performed efficiently to generate test circuit layers and full-chip designs, the realistic test circuit generation technology described herein may support widespread and efficient generation of test circuits, even at early development phases of a technology node. While generated test circuits may not provide actual chip functionality (since they are designed with random lay patterns), the mimicking of functional circuit designs and realistic layouts may allow for effective testing of technology nodes and corresponding manufacturing processes. Such technology may allow for quick, more efficient, and more effective testing of circuit manufacturing processes, allowing foundries to refine and improve such processes with increased effectiveness. While FIG. 2 shows an example of a single circuit layer, the test circuit generation engine 110 may generate test circuits of any size and scope.

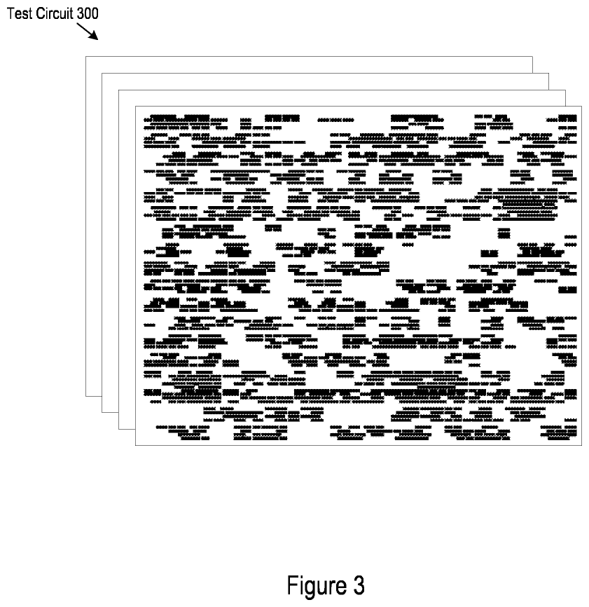

FIG. 3 shows an example of a test circuit that can be generated through the realistic test circuit generation technology of the present disclosure. In the example of FIG. 3, the test circuit generation engine 110 generations a full-chip design using the realistic test circuit generation technology of the present disclosure, show as a test circuit 300 in FIG. 3. In doing so, the test circuit generation engine 110 may generate multiple circuit layers of a chip design, and each layer may be generated through random placement of a building block library, e.g., the set of clean circuit layer blocks 220 of FIG. 2. In some implementations, the test circuit generation engine 110 may perform a chip-level DRC process on generated test circuit layer that applies a design rule set for a circuit manufacturing process. Then, the test circuit generation engine 110 may utilize the test circuit layers by generating a test chip design, e.g., by combining the test circuit layer with other generated test circuit layers to form the test circuit 300.

Note that the test circuit generation engine 110 need not address DRC errors in test circuit layers, thus avoiding costly debugging processes that may require manual work from chip designers. Through the efficiency of the realistic test circuit generation technology described herein, the test circuit generation engine 110 can readily generate a large number of test circuit layers, and utilize only those that pass DRC processes in building full-chip designs. For example, the test circuit generation engine 110 may combine a test circuit layer (e.g., the test circuit layer 230 of FIG. 2) with other generated test circuit layers that pass a chip-level DRC process (e.g., that applies the design rule set for the circuit manufacturing process). The multiple layers may then form a full-chip design (which can also be subject to the chip-level DRC process). For full chip testing and verification, the test circuit generation engine 110 may implement routing in a test-chip or perform any other suitable design process to mimic physical chip designs.

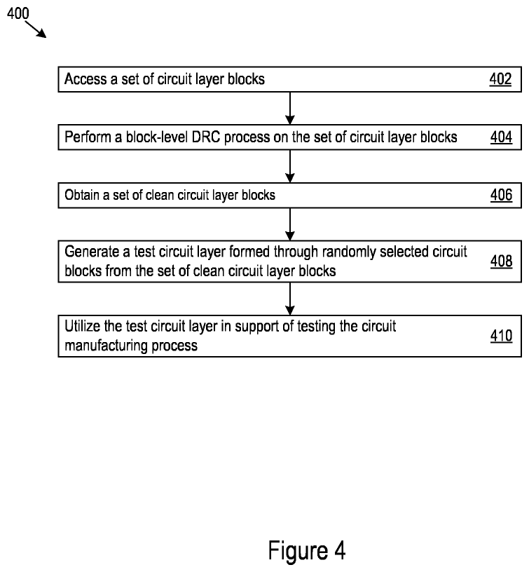

FIG. 4 shows an example of logic 400 that a system may implement to support realistic test circuit generation through random circuit layer blocks. For example, the computing system 100 may implement the logic 400 as hardware, executable instructions stored on a machine-readable medium, or as a combination of both. The computing system 100 may implement the logic 400 via the test circuit generation engine 110, through which the computing system 100 may perform or execute the logic 400 as a method to support realistic test circuit generations. The following description of the logic 400 is provided using the test circuit generation engine 110 as an example implementation. However, other implementation options by computing systems are possible.

In implementing the logic 400, the test circuit generation engine 110 may access a set of circuit layer blocks (402), which may be generated as random layout patterns and according to any number of block criteria as described herein. In implementing the logic 400, the test circuit generation engine 110 may further perform a block-level DRC process on the set of circuit layer blocks (404), wherein the block-level DRC process applies selected design rules that are a subset of a design rule set for a circuit manufacturing process and obtain a set of clean circuit layer blocks (406), for example doing so by discarding circuit layer blocks in the accessed set of circuit layer blocks that fail the block-level DRC process and keeping circuit layer blocks in the accessed set of circuit layer blocks that pass the block-level DRC process. In implementing the logic 400, the test circuit generation engine 110 may further generate a test circuit layer formed through randomly selected circuit blocks from the set of clean circuit layer blocks (408) and utilize the test circuit layer in support of testing the circuit manufacturing process (410).

The logic 400 shown in FIG. 4 provides an illustrative example by which a computing system 100 may support realistic test circuit generation through random circuit layer blocks according to the present disclosure. Additional or alternative steps in the logic 400 are contemplated herein, including according to any of the various features described herein for the test circuit generation engine 110.

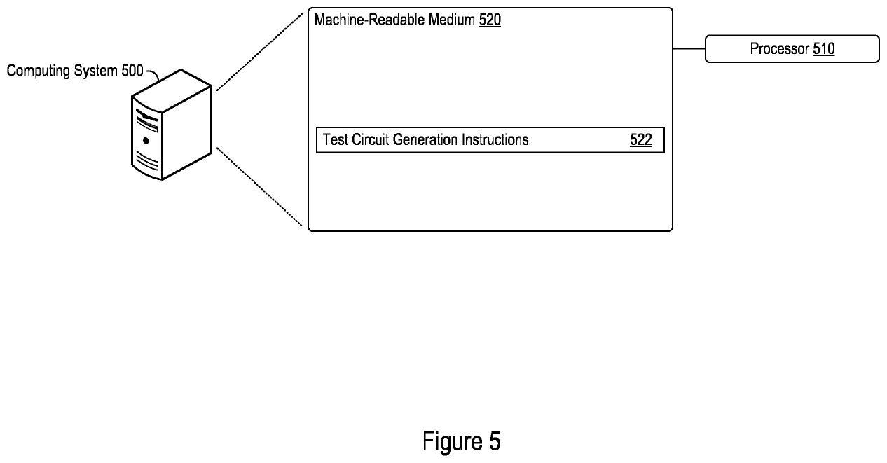

FIG. 5 shows an example of a computing system 500 that supports realistic test circuit generation through random circuit layer blocks. The computing system 500 may include a processor 510, which may take the form of a single or multiple processors. The processor(s) 510 may include a central processing unit (CPU), microprocessor, or any hardware device suitable for executing instructions stored on a machine-readable medium. The computing system 500 may include a machine-readable medium 520. The machine-readable medium 520 may take the form of any non-transitory electronic, magnetic, optical, or other physical storage device that stores executable instructions, such as the test circuit generation instructions 522 shown in FIG. 5. As such, the machine-readable medium 520 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 500 may execute instructions stored on the machine-readable medium 520 through the processor 510. Executing the instructions (e.g., the test circuit generation instructions 522) may cause the computing system 500 to perform or implement any of the realistic test circuit generation technology described herein, including according to any aspect of the test circuit generation engine 110.

For example, execution of the test circuit generation instructions 522 by the processor 510 may cause the computing system 500 to access a set of circuit layer blocks, which may be generated as random layout patterns and according to any number of block criteria as described herein. Execution of the test circuit generation instructions 522 by the processor 510 may further cause the computing system 500 to perform a block-level DRC process on the set of circuit layer blocks, wherein the block-level DRC process applies selected design rules that are a subset of a design rule set for a circuit manufacturing process and obtain a set of clean circuit layer blocks, for example doing so by discarding circuit layer blocks in the accessed set of circuit layer blocks that fail the block-level DRC process and keeping circuit layer blocks in the accessed set of circuit layer blocks that pass the block-level DRC process. Execution of the test circuit generation instructions 522 by the processor 510 may also cause the computing system 500 to generate a test circuit layer formed through randomly selected circuit blocks from the set of clean circuit layer blocks and utilize the test circuit layer in support of testing the circuit manufacturing process.

Any additional or alternative aspects of the realistic test circuit generation technology as described herein may be implemented via the test circuit generation instructions 522.

The systems, methods, devices, and logic described above, including the test circuit generation engine 110, may be implemented in many different ways in many different combinations of hardware, logic, circuitry, and executable instructions stored on a machine-readable medium. For example, the test circuit generation engine 110, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the test circuit generation engine 110.

The processing capability of the systems, devices, and engines described herein, including the test circuit generation engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples and features have been described above, many more implementations are possible.

1. A method comprising:
by a computing system:
accessing a set of circuit layer blocks;
performing a block-level design rule check (DRC) process on the set of circuit layer blocks, wherein the block-level DRC process applies selected design rules that are a subset of a design rule set for a circuit manufacturing process;
obtaining a set of clean circuit layer blocks by discarding circuit layer blocks in the accessed set of circuit layer blocks that fail the block-level DRC process and keeping circuit layer blocks in the accessed set of circuit layer blocks that pass the block-level DRC process;
generating a test circuit layer formed through randomly selected circuit blocks from the set of clean circuit layer blocks; and
utilizing the test circuit layer in support of testing the circuit manufacturing process.

2. The method of claim 1, wherein the accessed set of circuit layout blocks comprise circuit layout blocks of differing size.

3. The method of claim 1, wherein accessing the set of circuit layout blocks comprises generating the set of circuit layout blocks as random layout patterns for a circuit design.

4. The method of claim 3, comprising generating the set of circuit layout blocks as random layout patterns that stress the selected design rules of the circuit manufacturing process.

5. The method of claim 1, further comprising performing a chip-level DRC process on the test circuit layer that applies the design rule set for the circuit manufacturing process.

6. The method of claim 1, wherein utilizing the test circuit layer comprises generating a test chip design by combining the test circuit layer with other generated test circuit layers.

7. The method of claim 6, comprising combining the test circuit layer with other generated test circuit layers that pass a chip-level DRC process that applies the design rule set for the circuit manufacturing process.

8. A system comprising:
a processor; and
a non-transitory-machine readable medium comprising instructions that, when executed by a processor, cause a computing system to:
access a set of circuit layer blocks;
perform a block-level design rule check (DRC) process on the set of circuit layer blocks, wherein the block-level DRC process applies selected design rules that are a subset of a design rule set for a circuit manufacturing process;
obtain a set of clean circuit layer blocks by discarding circuit layer blocks in the accessed set of circuit layer blocks that fail the block-level DRC process and keeping circuit layer blocks in the accessed set of circuit layer blocks that pass the block-level DRC process;
generate a test circuit layer formed through randomly selected circuit blocks from the set of clean circuit layer blocks; and
utilize the test circuit layer in support of testing the circuit manufacturing process.

9. The system of claim 8, wherein the accessed set of circuit layout blocks comprise circuit layout blocks of differing size.

10. The system of claim 8, wherein the instructions cause the computing system to access the set of circuit layout blocks by generating the set of circuit layout blocks as random layout patterns for a circuit design.

11. The system of claim 10, wherein the instructions cause the computing system to generate the set of circuit layout blocks as random layout patterns that stress the selected design rules of the circuit manufacturing process.

12. The system of claim 8, wherein the instructions further cause the computing system to perform a chip-level DRC process on the test circuit layer that applies the design rule set for the circuit manufacturing process.

13. The system of claim 8, wherein the instructions cause the computing system to utilize the test circuit layer by generating a test chip design by combining the test circuit layer with other generated test circuit layers.

14. The system of claim 13, wherein the instructions cause the computing system to combine the test circuit layer with other generated test circuit layers that pass a chip-level DRC process that applies the design rule set for the circuit manufacturing process.

15. A non-transitory machine-readable medium comprising instruction that, when executed by a processor, cause a computing system to:
access a set of circuit layer blocks;
perform a block-level design rule check (DRC) process on the set of circuit layer blocks, wherein the block-level DRC process applies selected design rules that are a subset of a design rule set for a circuit manufacturing process;
obtain a set of clean circuit layer blocks by discarding circuit layer blocks in the accessed set of circuit layer blocks that fail the block-level DRC process and keeping circuit layer blocks in the accessed set of circuit layer blocks that pass the block-level DRC process;
generate a test circuit layer formed through randomly selected circuit blocks from the set of clean circuit layer blocks; and
utilize the test circuit layer in support of testing the circuit manufacturing process.

16. The non-transitory machine-readable medium of claim 15, wherein the accessed set of circuit layout blocks comprise circuit layout blocks of differing size.

17. The non-transitory machine-readable medium of claim 15, wherein the instructions cause the computing system to access the set of circuit layout blocks by generating the set of circuit layout blocks as random layout patterns for a circuit design.

18. The non-transitory machine-readable medium of claim 17, wherein the instructions cause the computing system to generate the set of circuit layout blocks as random layout patterns that stress the selected design rules of the circuit manufacturing process.

19. The non-transitory machine-readable medium of claim 15, wherein the instructions further cause the computing system to perform a chip-level DRC process on the test circuit layer that applies the design rule set for the circuit manufacturing process.

20. The non-transitory machine-readable medium of claim 15, wherein the instructions cause the computing system to utilize the test circuit layer by generating a test chip design by combining the test circuit layer with other generated test circuit layers that pass a chip-level DRC process that applies the design rule set for the circuit manufacturing process.
